(19) United States
(12) Patent Application Publication
(10) Pub. No.: US 2013/0211911 A1
(43) Pub. Date: Aug. 15, 2013

(54) PERMISSIONED USE PREDICTIVE INTERACTIONS

(71) Applicant: Mark Krietzman, Palos Verdes Estates, CA (US)

(72) Inventor: Mark Krietzman, Palos Verdes Estates, CA (US)

(21) Appl. No.: 13/763,737

(22) Filed: Feb. 11, 2013

Related U.S. Application Data
(60) Provisional application No. 61/596,737, filed on Feb. 9, 2012.

(51) Int. Cl. G06Q 30/02

(52) U.S. Cl. CPC G06Q 30/0255
USPC 705/14.53

(57) ABSTRACT

Competition for Consumers in the marketplace is a billion dollar industry. Retention and acquisition of customers is important for many financial services entities. Disclosed herein is a system and method for a specific source to be permitted by a specific User to utilize computing devices and servers to acquire, parse, analyze and otherwise D-INE™ “data mine with permission” User Records which have been previously acquired and/or mined by third parties. Alpha Source in some instances applying its schemas to said User records utilizes its analysis to provided predictive information and offers to said User.

### RELATED APPLICATION

This application claims the full Paris Convention benefit of and priority to U.S. provisional application 61/596,737, filed Feb. 9, 2012 the contents of which are incorporated by this reference, as if fully set forth herein.

### FIELD

This disclosure relates to alpha source's permissioned use of a specific user's records agglomerated or kept by a non alpha source entity.

### GENERAL BACKGROUND

Banks, financial institutes, governmental entities, wholesale entities, retail entities, search engines, social media and others scrap, monitor, track, store, collect and parse the data and/or metadata of users who interact via computing devices to the internet, cellular towers, cable televisions systems, cat navigators, satellite television and the like.

User's in some instances unknowingly acquiesce to tracking and collection/agglomeration of their data and metadata. In some instances t relieve themselves of constant pop-up requests a User will click on it and inadvertently or intentional agree to what is a contact of adhesion. Even if a user may knowingly acquiesce the question remains whose property is a persons data and meta data? It is compelling that traditionally the online world refers to such data and metadata as the User or customer's data or metadata thereby recognizing the source and potential ownership interest.

The pursuit of customers and the need to reduce customer churn are business realities. A User who access an Amazon.com portal will be familiar with the predictive use of collected data to attempt to offer, inform and sell goods to that User.

Forward thinking institutions such as offer products that help customers manage multiple accounts at different institutions. A Morgan Stanley product known as “Total View” is billed as “ a personal financial management application that provides you with a comprehensive set of tools, such as spending reports, budgeting and transaction management to help you consolidate and manage all of your finances in one place.”

### DISCLOSURE

A Source of data and meta data about one or more specific individuals (also referred to a User or Users) includes those entities in which the User has an account or has registered or identified themselves.

A market advantage may be obtained by a Source which is able to use predictive analytics to anticipate a customer (User) needs, wants, likes, dislikes etc. Traditionally a source will rely on its own collects of information it acquired on a User to build analytic models for a User. Disclosed herein is a method and system whereby a User with rights to the data amassed on said User by Sources, data agglomerators and the like is consolidated by a specific source which is referred to herein as an Alpha Source via express permissions by the User wherein the Alpha Source, in some implementations, will one or more of collect, review search, filter, parse and utilize the records collected or accessed to build better analytical models concerning the User and in support of information and offers and refinement of such activities i.e. making offers to Users, providing information to Users and even in how a Alpha Source communicates with User.

Other Sources include Financial Services Entity are Sources which provide economic services which encompasses a broad range of organizations that manage money, including credit unions, banks, credit card companies, annuities, funding, insurance companies, consumer finance companies, stock brokerages, investment funds and some government sponsored enterprises. Some financial service entities include, but are not limited to, HSBC, JP Morgan Chase, Bank of America, Wells Fargo, Mitsubishi Tokyo Financial Group, Goldman Sachs, MSSB, RBC, Citigroup, E-trade, Prudential, MetLife and the like. Additional Sources of collected data and meta data are governmental offices (i.e. secretary of State, Post Office, IRS) educational institutions, financial services, municipalities, investment firms, trading exchanges, tax services, book keeping, advisory services, online auctions, online purchasing portals such as Apple, Google or Amazon where the User has an Account which tracks or keep records of at least one of a User's spending, habits, browsing habits, family relations, friends, travel, location, time or date of spending, time or date of browsing, spending choices, likes and dislikes, rates of return, finances charges, payments, investments, investment choices or selections, patterns, buying habits, buying, and selling patterns through a financial transaction.

For verification a User may be identified in a variety of ways including but not limited to done or more of via phone number, account number, voice, retina, dna, face, fingerprint, other biometric measure, password, User ID, IP address, IP provider.

Laws are evolving globally on privacy. Specifically, sovereigns may have different restrictions on data agglomerator Sources, Laws include those concerning ownership or other access rights to such User records and the use of such records.

User refers to a specific individual.

Controlled Servers means a server which a Source has ownership of, leases, rents, or otherwise has control over at least a portion of the data and meta data thereon including so called cloud storage. These include archive servers, third party server space utilized for the Source.

Permissioned to access on a User's behalf refers to express permission including with User express consent and express agreement or express instruction.

Permission may take different forms, a key detail with express permission from a User is that the User is not a minor is able to give consent and the consent is obtained. Permissions may include User supplied account information like account numbers, passwords, answers to security questions, address, IP address, SSN (social security number), passport, driver's license and family background information. A Source when acting with express permission of a User is designated for ease of description as the “Alpha Source”. An Alpha Source refers to a specific member of the group identified herein as Source or Sources except that this Source is acting based on express permission of a User to provide the User information and offers based at least in part on the Alpha Source's analysis of at least one of User habits, spending, finance, and fiancé parameters and other activity reflected in User records collected, amassed, obtained by, mined by, and the like by Sources.

Data mined from accounts of a user by the permitted Alpha Source may be referred to D-INE (which means expressly permitted data mining).

A User may expressly permit an Alpha Source to D-INE or act on its behalf. Such permission may include acquisition from the User of all necessary information or data to acquire User data or meta held or collected by a specified entity or organization (Source) or a User may permit the Alpha Source to Use Alpha Source records of User personal data to complete access or login requirements at other Source 1 . . . Source N to obtain access to data and meta data records (User Records). Naturally, the access information may also be developed through a combination of Alpha Source records of the User and User supplied information.

Permissioned access in some instances may include a User giving Alpha Source status, rights, agency or the like to appoint, empower or authorize Alpha Source to act for User and directly request User Records and accept Source terms of use or other necessary agreements to access said User Records from Sources. For Sources an Alpha Source may be empowered to pursue legal or administrative means on behalf of User to obtain mined, scrapped or collected User records.

Source List refers to known Sources other than Alpha Source, which have User Records. These are entities a User identifies as a Source.

Target List refers to Sources which have or may have User Records. These include big data agglomerators or spyware. A User may have agreed to allow a Source to collect data on User but may be unaware that said data has been shared with or handed over to or collected by an agglomerator working with or on behalf of a Source such agglomerators are sometimes referred to as Targets.

Server is not limited to a single server. Server is not limited to Source or Target owned equipment. Servers include devices which can access Source or Target archives of digital information and files. Target or Source servers may be owned, leased, rented or provided by another.

The system, its rule engine(s) and decision engine(s) utilizing processors in some exemplary implementations, obtains, stores, creates tables of, reviews, parses, selects, calculates or otherwise filters account parameter digital data provided or obtained in a machine readable code, via disk, hard drive, network, internet for use

Once the needs/wants of a User are known or calculated a User may welcome useful and relevant market information on goods or services that have a high probability of fitting a User's needs/wants. Such information may include services, discounts, goods, insurance, rewards, advertisements, coupons, selections, codes, specials, benefits, give-aways, freebie, lotteries, internet links to any of the above.

The difference between market information and marketing offers is that an offer goes beyond informing a User about the existence of goods and services. Rather a marketing offer includes an “offer” it may be discounts, goods, services, rewards, services, insurance, advertisements, coupons, selections, codes, specials, benefits, give-aways, freebie, lotteries, internet links to any of the above. Market offers may be limited in time, limited by qualification, limited in number, limited to certain persons, or limited by geographical location.

A Computing Device means a machine for performing calculations automatically. Smart phones, computers, laptops, desktops, tablets, automobile navigators, PDAs, gaming systems are examples of computing devices.

Habit Records are data or metadata on a User's patterns of activity, may include when User views accounts at a particular Source or when User logs on or off internet. Non-exclusive patterns include time of spending broken down by time units from minutes to months or years. Such consumer activity includes but is not limited to categories of purchases, times of purchases, timing or amount of purchase for specific goods or services. Relationship between a good or service purchased. Repetition of purchases, patterns of purchases. Geographic location when an activity takes place, Internet browsing history before, during or after a specific purchase. A habit would be call Mom on Monday call Dad on Friday on a regular basis. A habit includes setting a wake up alarm at a specific time on a regular basis. A habit is where you fill up for gasoline and when. I habit would include repetitively going to Google to find a product, go to a specific product site and then go to Amazon to price the product. Repetitively on Mon-Thursday going back to a certain website such as Finance on stock prices or commodity prices. Habits can include repeating an action such as spending money on the 16^{th} of every month or items A, B and C. What A, B and C are will be Spending records but making the same spending choice on a regular basis is a habit.

Spending Actions are data or metadata on a User's spending activity and patterns of spending. A non-exclusive, non-limiting, pattern would be dates of direct deposits of salary, any direct deposit date. Average daily balance and the like on non-revolving credit savings or checking accounts within 1 day to 7 days before a specific purchase. Activity on non-revolving credit savings or checking accounts within 1 day to 14 days before or after a specific purchase. Activity on non-revolving credit savings or checking accounts within 1 day to 30 days before or after a specific purchase. Activity on non-revolving credit savings or checking accounts within 1 day to 60 days before or after a specific purchase. Activity on non-revolving credit savings or checking accounts before or after a specific purchase. Activity on revolving accounts within 1 day to 7 days before or after a specific purchase. Activity on revolving credit accounts within 1 day to 14 days before or after a specific purchase. Activity on revolving credit accounts within 1 day to 30 days before or after a specific purchase. Activity on revolving credit accounts within 1 day to 60 days before or after a specific purchase. Activity on revolving credit savings or checking accounts before or after a specific purchase.

Performance are data or metadata on a User's accounts and may be further broken down into things such as terms and conditions, passive growth and active growth of wealth or assets. Account terms, conditions and growth, either passive or active have components which may include rates, penalties, credit terms, grace periods, minimum payments, costs, cost of cash advances, cost access to User's money, margins, fees, results, results over time, tax consequences, risks, and institutional nepotism. Growth or wealth acquisition accounts include but are not limited to savings, CDs, currency funds, bonds, stocks, private equity, hedge funds, trading, indexed funds, mutual funds, futures, options, commodities, investments, REITs, real estate, securities, and trusts.

Benefits associated with typical User accounts or in accounts which may be offered to a User. A non exclusive list of some benefits, include specials, discounts, offers, promotions, entertainment access to specials reward points, bonus points, hotels rates, airfare or other travel related goods or services, travel lounge access, mechanism for resolving identity theft, mechanism to prevent fraud, limits, locations, hours of support centers, and concierge.

In some exemplary implementations there is disclosed aspects of a method and system of predictive Alpha Source product offerings, comprising: a verified User connects with Alpha Source server; user's Computing Devices interfaces with Alpha Source servers and create a Target List identifying User accounts at non Alpha Source; User supplies or verifies account information to give Alpha Source access to User Records or to allow Alpha Source to request User Records from Targets; Alpha Source, with express permission from User analyzes and filters obtained Records via rules and decisioning engines, software and algorithms; User activity records are identified; User Activity records are parsed into at least habit records and spending action records; and, predictive models and analytics are applied to User Activity records to identify offers likely to be predictive of User wants, needs and likes. The disclosure, in some instances, encompasses if a determination of potentially predictive then provide market information to User. The disclosure, in some instances, encompasses creating a database entry with the analytics that resulted in the determination of predictive. The disclosure, in some instances, encompasses creating a database entry with the analytics that resulted in the determination of not predictive. The disclosure, in some instances, encompasses creating the target list may include confirming, adding to, editing and deleting Alpha Source suggestions. The disclosure, in some instances, encompasses creating the target Alpha Source may obtain permission from User to obtain and use User credit report data to suggest Sources 1 . . . N to add to Target list. The disclosure, in some instances, encompasses determining if User acted on predictive information provided to User by Alpha Source on a activity or purchase.

In some exemplary implementations there is disclosed aspects of a method and system of predictive Alpha Source product offerings, the method comprising: a verified User connects with Alpha Source server; user's Computing Devices interfaces with Alpha Source servers and create a Target List identifying User accounts at non Alpha Source. User supplies or verifies account information to give Alpha Source access to User Records or to allow Alpha Source to request User Records from Targets; Alpha Source, with express permission from User analyzes and filters obtained Records via rules and decsioning engines, software and algorithms; User activity records are identified; User Activity records are parsed into at least habit records and spending action records; and, predictive models and analytics are applied to User Activity records to identify offers likely to be predictive or fit User wants, needs and likes. The disclosure, in some instances, encompasses if predictive then provide market information to User. The disclosure, in some instances, encompasses creating a database entry with the analytics that resulted in the determination of predictive. The disclosure, in some instances, encompasses creating a database entry with the analytics that resulted in the determination of not predictive. The disclosure, in some instances, encompasses identifying if User acted on offer provided to User by Alpha Source on an activity or purchase.

In some exemplary implementations there is disclosed aspects of a method and system of predictive analytics, the method comprising: an Alpha Source with user express permissions accesses User records from Targets;Alpha Source analyzes and filters obtained records via rules and decsioning engines, software and algorithms; User Activity records are parsed into at least habit records and spending action records; and, predictive models and analytics are applied to one of User spending actions and habits to identify offers likely to be predictive or fit User wants, needs and likes. The disclosure, in some instances, encompasses analyzing if User acted on offer provided to User by Alpha Source on an activity or purchase.

### FIGURES

The disclosure may be better understood by referring to the following figures. The components in the figures are not necessarily to scale, emphasis instead being placed upon illustrating the principles of the disclosure.

FIG. 1 is a method overview;

FIG. 2 is an exemplary implementation of a system and method disclosed here;

FIG. 3 is an exemplary implementation of a system and method disclosed herein;

FIG. 4 is an exemplary implementation of a system and method disclosed herein; and,

FIG. 5 is an exemplary implementation of determining the effectiveness of market information or offers predicted to be appropriate for a determined goal.

All descriptions and callouts in the Figures are hereby incorporated by this reference as if fully set forth herein.

### FURTHER DISCLOSURE

Data connected to a private User (not in the pubic eye or public domain) may have an expectation of some level of privacy. Constructs of User profiles of potential wants, interests, needs, habits, likes, and dislikes to approximate a User based on a User's activities as represented by data and meta data mined, scraped, monitored, tracked, observed and otherwise collected about same from single or multiple sources may now or in the future have privacy protection. The within disclosure recognizes a spectrum of personal expectations of privacy and the reality of changing and evolving laws and policies from sovereign nation to sovereign nation in this arena. The disclosure should be given the broadest possible interpretation consistent with the laws of the sovereign nation it is being applied for in, at the time of its application or enforcement.

In some implementations, a permissioned method and system to construct User profiles is disclosed. A data agglomerator, Source, or a third party may have parsed said data and metadata for its own use—a fundamental question remains—at the end of the day what are the ownership rights of the individual versus the institution. Laws are evolving regarding a person's data and associated metadata.

Some Sources acquired or mine information about a User using various known means employed via the internet and software which fish, spy, tracking, monitor and otherwise snoop for User habits, activity, data and metadata.

Disclosed in some aspects of implementation herein is an Alpha Source having express User permission to D-INE, access, acquire and in a sense “mine” the very User records that have been taken without express permission. In some instances Alpha Source acts as an agent of User to mine other sources who may also be Alpha Source competitors which have previously data mined the User or who have User Records. This level of express permissioned access provides Alpha Source a universe of User Records to analyze, parse value and utilize.

An Alpha Source may utilize the User records amassed, collected, generated and in/or connected to the User whereby the Alpha Source decisioning engines use the User records to provide the User information and/or offers on good and services. Marketing based on permissioned access of User records supports predictive analytics to provide User information and/or goods and services which more closely track the likes, wants and needs of User.

Alpha Source servers D-INE, collect, analyze, and organize User Records at non Alpha Source sources. Alpha Source servers may also collect publically available Records related to Sources which may be of interest to User including but not limited to stories, video, audio, news, social media, complaints, penalties, investigations, awards, class action lawsuit, antitrust claims and the entire spectrum of accounting, legal or ethical awards, complaints, articles, opinions, charges, allegations and determinations.

The User data from the User records is added to a database established via Alpha Source schemas. The database may be at least one of a relational or non relational database. In some instances at least some of the data of various categories C1 . . . CN is collected into groups based on traits the decision engines is analyzing for a specific User. In some instances at least some of the data of various categories C1 . . . CN is collected into groups based on predictive grouping selected by Alpha Source outside of a specific User. In some instances at least some of the data of various categories C1 . . . CN is collected into groups based on grouping selected by Alpha Source. In some instances at least some of the data of various categories C1 . . . CN is collected into groups based on grouping selected by Alpha Source to compare an/or contrast Alpha marketing of services or goods. Alpha Source accounts are a product, goods Alpha Source points User towards or pushes towards User are goods. Services Alpha Source accounts are a services.

Persons of ordinary skill in the art of computer programming will recognize that the disclosure herein references operations that are performed by a computer system. Operations which are sometimes referred to as being computer-executed. It will be appreciated that such operations are symbolically represented to include the manipulation by a processor, such as a cpu, with electrical signals representing data bits and the maintenance of data bits at memory locations, such as in system memory, as well as other processing of signals. Memory locations wherein data bits are maintained are physical locations that have particular electrical, magnetic, optical, or organic properties corresponding to the data bits.

When implemented in software, elements disclosed herein are aspects of some of the code segments to perform necessary tasks. The code segments can be stored in a non-transitory processor readable medium, which may include any medium that can store information. Examples of the non-transitory processor readable mediums include an electronic circuit, a semiconductor memory device, a read-only memory (ROM), a flash memory or other non-volatile memory, an optical disk, a hard disk, etc. The term module may refer to a software-only implementation, a hardware-only implementation, or any combination thereof. Moreover, the term servers may both refer to the physical servers on which an application may be executed in whole or in part.

A win-win situation exists when a customer or User obtains a personalized set of materials that reflect their choices, needs and wants and an Alpha Source (such as a bank) obtains valuable data analytics and/or reduce customer churn.

User Records are parsed into at least Habits and non-habits. They may be further parsed for use with Alpha Source data analytics. Alpha Source utilizes its rule and/or decision engines, software and algorithms to mine the collected User records. Alpha Source schemas, databases and data dictionaries are constructed from, are related to, or reflect information in User records or analysis thereof.

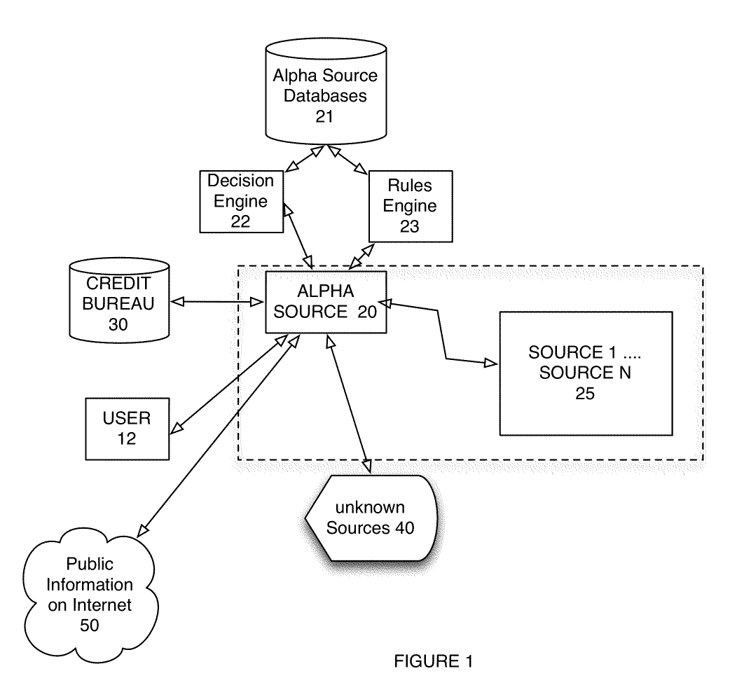

FIG. 1 provides an overview of a system 10 of permitted use of a User Records. A User 12 via a computing device interacts with an Alpha Source 20

The Alpha Source 20 utilizes at least a decision engine 22 in its operations, a Rules engine 23 may also be applied. Alpha Source may be a member of a group of Source 25. Sources “1” through source “N” 25 are shown in the group of sources. In addition to interacting with a User, via the user's computing device and the Alpha Source server(s). The Alpha Source 20 also may interact with credit bureau 30 servers. The Alpha Source 20 has servers with or linked to databases 21. Alpha Source may also interact with unknown Sources 40. Unknown Sources may agglomerate User Records or may act on behalf of agglomerates. Alpha Source may also utilize available online public information 50 from news source, blogs, .orgs, as well as that published or made available by sources 1 . . . N on the internet. A web crawler (not shown) is one mechanism for Alpha Source to retrieve such public information.

In exemplary implementations Alpha Source utilizes its relationship, connection, associate and/or position of trust with the User to in some instances benefit the User and in other instances benefit the Alpha Source, and in some cases benefit both. Visa vie the systems and methods herein, Alpha Source obtains access to its competitors, Sources 1 . . . N.

Access may be in any number of commercially and technologically know ways including but not limited to native format, usable, via an e-mail attachment from Source to Alpha Source, access to Source servers; via memory disk, drive or archive. Such an archive may be remote from Source and may be an electronic escrow of a User's records, Those of ordinary skill in the art will understand this collection and/or transfer of Source digital records of User to Alpha Source to be achievable with a plethora of tools well known.

User activity record include Habits and Spending Actions which are utilized in predictive analytics to fine tune marketing, products and services to User. Source specific records also include Performance records that can include records concerning assets and liabilities of at least one of passive and active investment accounts items that impact or could impact a User's finances, wealth or net worth.

Disclosed are methods and systems include those to preserve or grow User's wealth. In preserving or growing wealth costs and fees charged to a User are relevant. Also choices a investment group, bank or other Source makes for or with User regarding investments and the performance thereof impact wealth and worth and liabilities. Any strategy a Source deployed for a User account is relevant. Disclosed herein are methods and systems whereby a permitted Alpha Source evaluates User account records at a Source including but not limited to costs, fees and choices for User. The evaluation provides information that can be reported by Alpha Source to User on success and failures of Source. The evaluation gives Alpha Source information on what might be comparable or superior Alpha Source account products.

In some exemplary implementations by way of reviewing Source 1 . . . N account parameters (both online and User records) Alpha Source may summarize the cost to User of working with Source 1 . . . N versus the cost of working with Alpha Source. The Summary may be provided online, in a report (electronic or paper) or in an other User accessible format via a User's computing device.

Marketing methods and system involve analysis, review and filtering of User activity to at least partially factor into marketing offers made to User. Some examples include habits, purchases, browsing timing and activity in relation to other activities which may indicate buying patterns or may be predictive of purchasing or other use of User resources. Alpha Source can make market offers to User including but not limited to discounts, rewards, advertisements, coupons, selections, codes, specials, benefits, give-aways, freebie, lotteries, internet links to any of the above. Market offers may be limited in time, limited in number or limited by geographical location. Marketing offers may be predictive on timing to track periods wherein User is more likely to be receptive to such offers. For example if records show User tends to have more spending activity on the beginning of third week of each month, that third week may be predictive. Alternatively, if User has e-filed taxes and such User Records are reviewed timing marketing offers with tax refunds may be predictive.

Benefits refer to another subgroup of Source specific User records. After analyzing Source Records and publically available information Alpha Source may summarize Source 1 . . . N benefits or lack thereof to User. Alpha Source having the benefit of Source 1 . . . N User Records may make User offers of one of predictive benefits or better benefits.

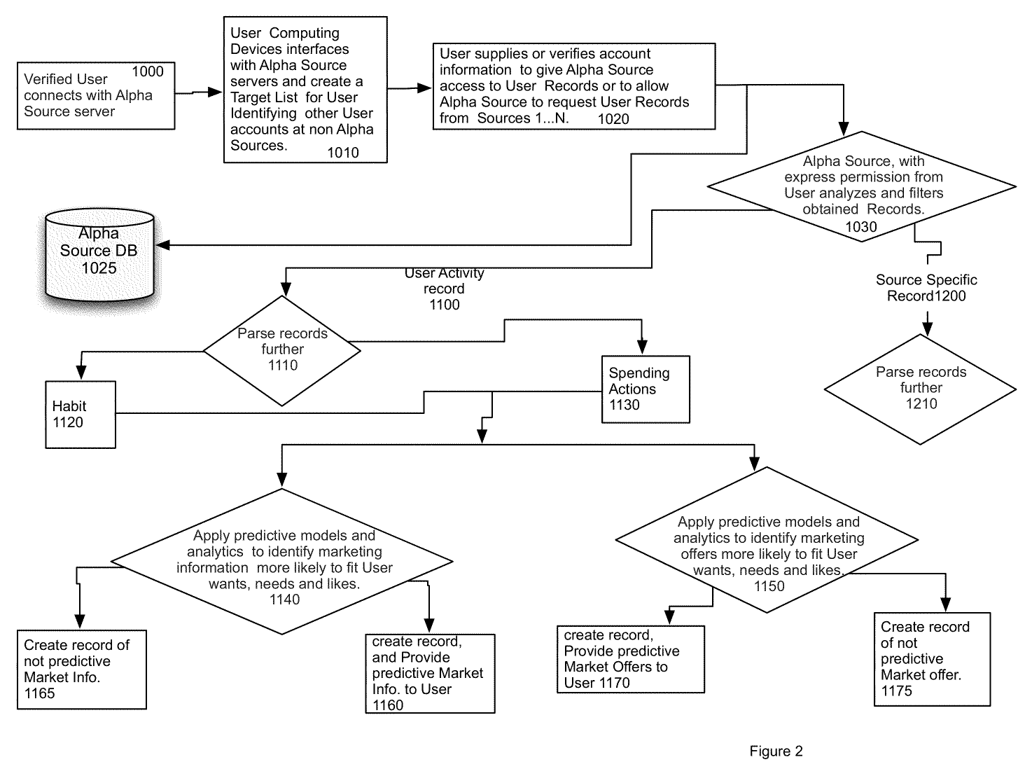

User records can be broadly group into several areas. There are different ways to arrange groupings. FIG. 2 illustrates a broad grouping dividing Source Specific Records related to Source products User utilizes from User Activity records. FIG. 2 illustrates another broad grouping dividing Source Specific Records from User Activity records and also further dividing out Benefit records of Source 1 . . . N products User accounts have.

FIG. 2 illustrates aspects of exemplary implementations of a method and system utilizing permissioned User records to form marketing information and offers predictive of User wants, needs or likes. Such marketing offers also may include a personalized aspect of terms, pricing or conditions based on a relationship between User and Alpha Source.

### EXAMPLE 1

### Marketing to User

Verified User connects with Alpha Source server 1000. Alpha Source can be, but is not required to be, a financial services entity. A verified User is one that the Alpha Source confirms to meet the Alpha Sources requirements of authentication of a specific User. Requirements may include but are not limited to IP address, MAC address, phone number, password, voice, retinal scan, drivers license, passport, security questions and geographic location. A series of identification questions, establishing the User's identity including but not limited to providing a social security number, answering questions that collectively only the correct User might know, such as “When is your birthday,” “At which bank did you open your first bank account”. The User may need to answer a series of questions to establish identity. Additionally, the User may be provided a verification code when he or she is initially contacted, such as when the User receives an email or text message. Other methods of verification may be used, including but not limited to facial, voice and/or retinal recognition hardware and software, fingerprint recognition and other biometrics;

User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List;

User supplies or verifies account information to give Alpha Source access to User Records or to allow Alpha Source to request User Records from Sources 1 . . . N. 1020

Alpha Source, with express permission from User analyzes and filters obtained Records via rules and decsioning engines, software and algorithms 1030;

Records are divided into at least two groupings consisting of User activity records 1100 and Source specific records 1200;

In this example, User Activity records are parsed further 1110 into at least habit records 1120 and spending action records 1130;

Obtained User records, data and meta data concerning the acquisition of the User records as well as the records are stored in a Alpha Source database 1025 which may be local to Alpha Source or remote;

Source specific records can be further parsed 1210;

Alpha Source servers apply predictive models and analytics to at least one of Habit and spending action records to identify marketing information more likely to fit, or be predictive of, User wants, needs and likes 1140;

If predictive then provide market information to User 1160, optionally a record may be created for Alpha Source with the basis and/or analytics that resulted in the determination of predictive; and,

If not predictive then optionally create record in Alpha Source database 1025 of non-predictive information and basis and/or analytics for determination of not predictive 1165.

### EXAMPLE 2

### Marketing to User

Verified User connects with Alpha Source server 1000;

User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List;

User supplies or verifies account information to give Alpha Source access to User Records or to allow Alpha Source to request User Records from Sources 1 . . . N. 1020;

Obtained User records, data and meta data concerning the acquisition of the User records as well as the records are stored in a Alpha Source database 1025 which may be local to Alpha Source or remote;

Alpha Source, with express permission from User analyzes and filters obtained Records via rules and decsioning engines, software and algorithms 1030;

Records are divided into at least two groupings consisting of User activity records 1100 and Source specific records 1200;

User Activity records are parsed further 1110 into at least habit records 1120 and spending action records 1130;

Source specific records can be further parsed 1210;

Alpha Source servers apply predictive models and analytics to at least one of Habit and spending action records to identify marketing offers more likely to fit, or be predictive of, User wants, needs and likes 1150;

If predictive then provide market offer to User 1170, optionally a record may be created for Alpha Source with the basis and/or analytics that resulted in the determination of predictive; and,

If not predictive then optionally create record in Alpha Source database 1025 of non-predictive offer and basis and/or analytics for determination of not predictive 1175.

In other exemplars of this disclosure and within the scope of this disclosure is tracking across User accounts at various sources or targets (based on foregoing or future actions) if User has acted upon Alpha Source offer by contacting, purchasing, using or investigating an offer and the time frame and mechanism of that activity.

### EXAMPLE 3

### Marketing Alpha Products to User

Verified User connects with Alpha Source server 1000;

User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List;

User supplies or verifies account information to give Alpha Source access to User Records or to allow Alpha Source to request User Records from Sources 1 . . . N. 1020;

Obtained User records, data and meta data concerning the acquisition of the User records as well as the records are stored in a Alpha Source database 1025 which may be local to Alpha Source or remote;

Alpha Source, with express permission from User analyzes and filters obtained Records via rules and decsioning engines, software and algorithms 1030;

Records are divided into at least two groupings consisting of User activity records 1100 and Source specific records 1200;

User Activity records can be parsed further 1110;

Source specific records are further parsed 1210 into at least performance records 1220 and Benefit records 1230;

Apply predictive models and analytics to identify Alpha Source product information more likely to fit User wants, needs and likes 1240;

If predictive then provide product information to User 1260, optionally a record may be created for Alpha Source and stored in a database 1025 with the basis and/or analytics that resulted in the determination of predictive; and,

If not predictive then optionally create record in Alpha Source database 1025 of non-predictive product and basis and/or analytics for determination of not predictive 1265.

In other exemplars of this disclosure and within the scope of this disclosure is tracking across User accounts at various sources or targets (based on foregoing or future actions) if User has acted upon Alpha Source information or offer by contacting, purchasing, using or investigating an offer and the time frame and mechanism of that activity.

### EXAMPLE 4

Marketing Alpha Products to User: Verified User connects with Alpha Source server 1000; User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List; User supplies or verifies account information to give Alpha Source access to User Records or to allow Alpha Source to request User Records from Sources 1 . . . N. 1020;

Obtained User records, data and meta data concerning the acquisition of the User records as well as the records are stored in a Alpha Source database 1025 which may be local to Alpha Source or remote;

Alpha Source, with express permission from User analyzes and filters obtained Records via rules and decsioning engines, software and algorithms 1030;

Records are divided into at least two groupings consisting of User activity records 1100 and Source specific records 1200;

User Activity records can be parsed further 1110;

Source specific records are further parsed 1210 into at least performance records 1220 and Benefit records 1230;

Apply predictive models and analytics to identify Alpha Source product offers more likely to fit User wants, needs and likes 1250;

If predictive then provide product offer to User 1270, optionally a record may be created for Alpha Source with the basis and/or analytics that resulted in the determination of predictive; and,

If not predictive then optionally create record in Alpha Source database of non-predictive product and basis and/or analytics for determination of not predictive 1275.

In other exemplars of this disclosure and within the scope of this disclosure is tracking across User accounts at various sources or targets (based on foregoing or future actions) if User has acted upon Alpha Source information or offer by contacting, purchasing, using or investigating an offer and the time frame and mechanism of that activity.

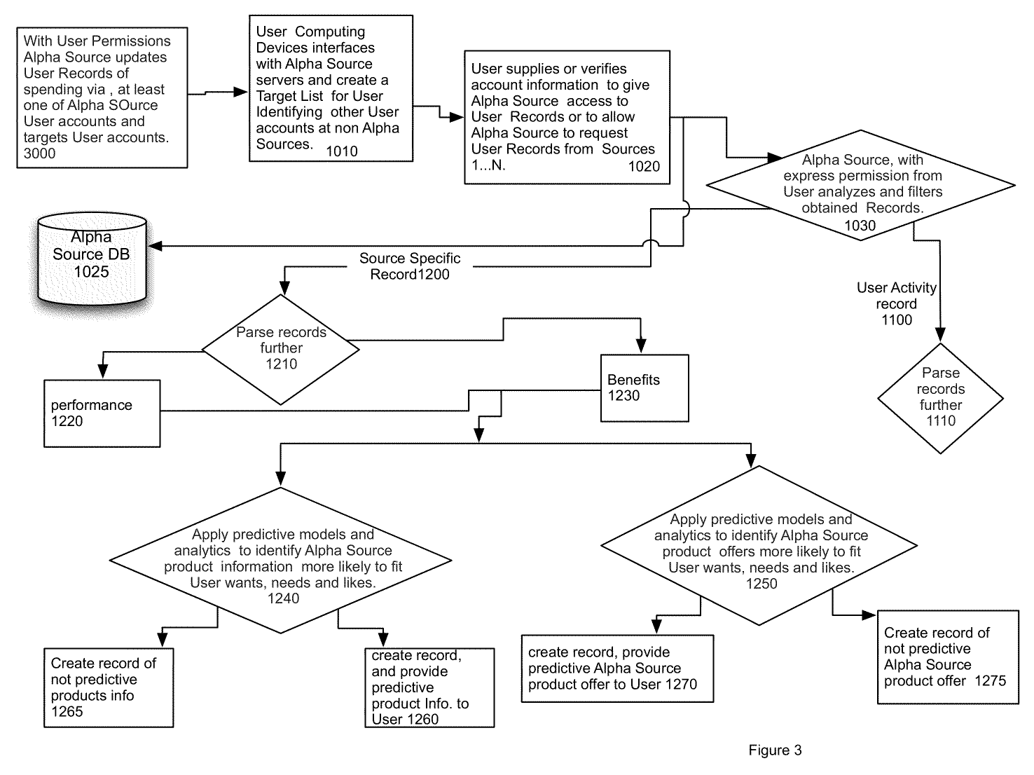

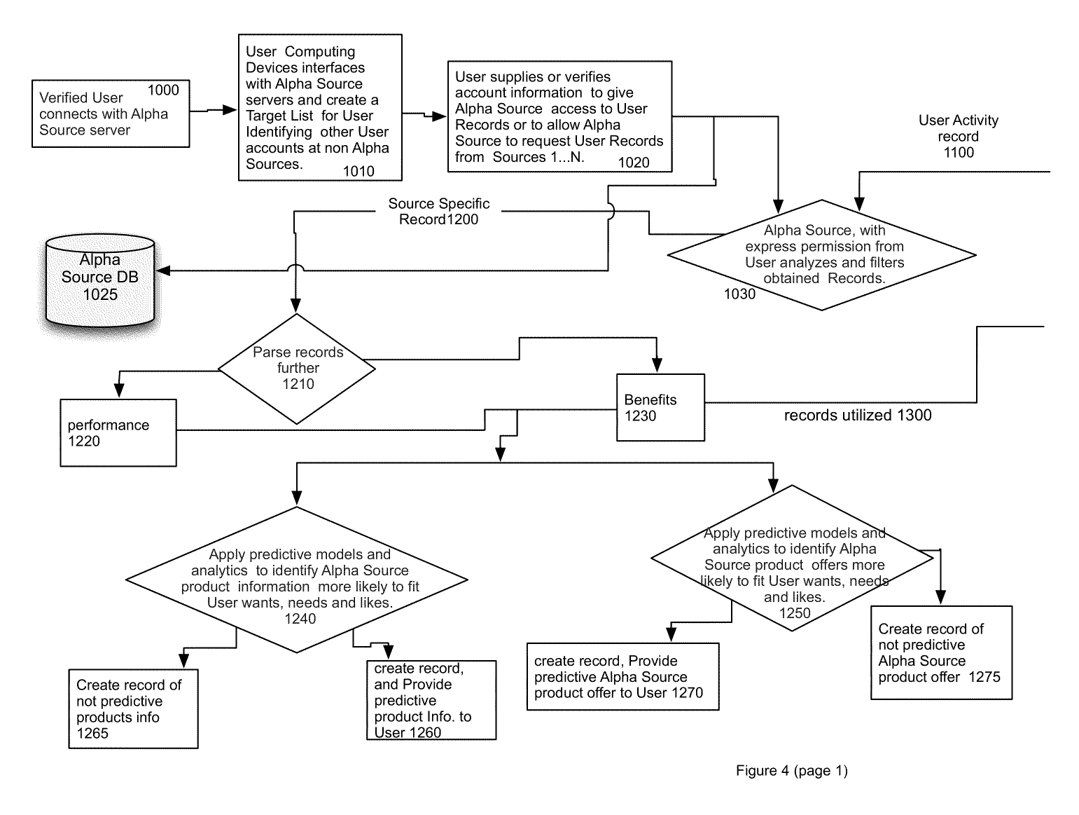

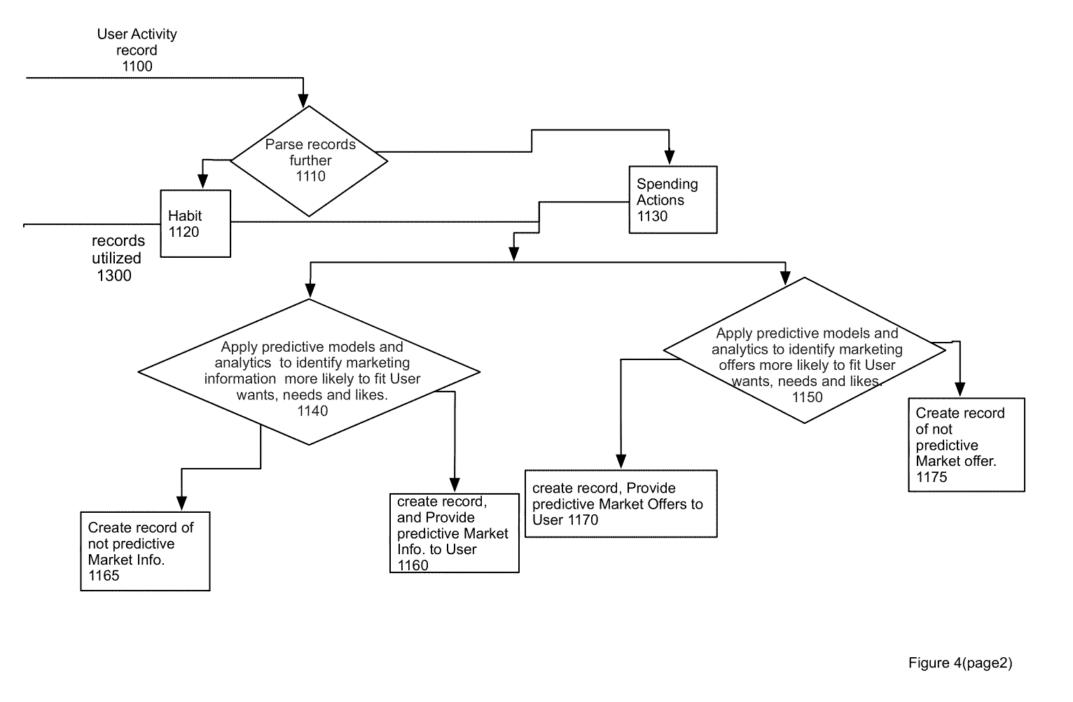

Utilizing at least both User Activity records and Source Specific records which Alpha Source collects with User's express permission, Alpha Source predictive analytics provide information, marketing offers and Alpha Source products predictive of User needs, likes and or wants. FIG. 4 agglomerates aspects of FIGS. 2 and 3.

### EXAMPLE 5

### Marketing Alpha G&S to User

Verified User connects with Alpha Source server 1000;

User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List;

User supplies or verifies account information to give Alpha Source access to User Records or to allow Alpha Source to request User Records from Sources 1 . . . N. 1020;

Obtained User records, data and meta data concerning the acquisition of the User records as well as the records are stored in a Alpha Source database 1025 which may be local to Alpha Source or remote;

Alpha Source, with express permission from User analyzes and filters obtained Records via rules and decsioning engines, software and algorithms 1030;

Records are divided into at least two groupings consisting of User activity records 1100 and Source specific records 1200;

User Activity records are parsed further 1110 into at least habit records 1120 and spending action records 1130;

Source specific records are further parsed 1210 into at least performance records 1220 and Benefit records 1230;

Apply predictive models and analytics to at least one User Activity record and one Source Specific Record to identify Alpha Source product information more likely to fit User wants, needs and likes 1240;

If predictive then provide product information to User 1260, optionally a record may be created for Alpha Source with the basis and/or analytics that resulted in the determination of predictive: and,

If not predictive then optionally create record in Alpha Source database of non-predictive product and basis and/or analytics for determination of not predictive 1265.

In other exemplars of this disclosure and within the scope of this disclosure is tracking across User accounts at various sources or targets (based on foregoing or future actions) if User has acted upon Alpha Source information or offer by contacting, purchasing, using or investigating an offer and the time frame and mechanism of that activity.

### EXAMPLE 6

### Marketing Alpha G&S to User

Verified User connects with Alpha Source server 1000;

User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List;

User supplies or verifies account information to give Alpha Source access to User Records or to allow Alpha Source to request User Records from Sources 1 . . . N. 1020;

Obtained User records, data and meta data concerning the acquisition of the User records as well as the records are stored in a Alpha Source database 1025 which may be local to Alpha Source or remote;

Alpha Source, with express permission from User analyzes and filters obtained Records via rules and decsioning engines, software and algorithms 1030;

Records are divided into at least two groupings consisting of User activity records 1100 and Source specific records 1200;

User Activity records are parsed further 1110 into at least habit records 1120 and spending action records 1130;

Source specific records are further parsed 1210 into at least performance records 1220 and Benefit records 1230;

Apply predictive models and analytics to analytics to at least one User Activity record and One Source Specific Record to identify Alpha Source product offers more likely to fit User wants, needs and likes 1250;

If predictive then provide product offer to User 1270, optionally a record may be created for Alpha Source with the basis and/or analytics that resulted in the determination of predictive; and,

If not predictive then optionally create record in Alpha Source database of non-predictive product and basis and/or analytics for determination of not predictive 1275.

In other exemplars of this disclosure and within the scope of this disclosure is tracking across User accounts at various sources or targets (based on foregoing or future actions) if User has acted upon Alpha Source information or offer by contacting, purchasing, using or investigating an offer and the time frame and mechanism of that activity.

### EXAMPLE 7

### Marketing to User

Verified User connects with Alpha Source server 1000;

User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List;

User supplies or verifies account information to give Alpha Source access to User Records or to allow Alpha Source to request User Records from Sources 1 . . . N. 1020;

Obtained User records, data and meta data concerning the acquisition of the User records as well as the records are stored in a Alpha Source database 1025 which may be local to Alpha Source or remote;

Alpha Source, with express permission from User analyzes and filters obtained Records via rules and decsioning engines, software and algorithms 1030;

Records are divided into at least two groupings consisting of User activity records 1100 and Source specific records 1200;

User Activity records are parsed further 1110 into at least habit records 1120 and spending action records 1130;

Source specific records are further parsed 1210 into at least performance records 1220 and Benefit records 1230;

Alpha Source servers apply predictive models and analytics to at least one User Activity record and one Source Specific Record to identify marketing offers more likely to fit, or be predictive of, User wants, needs and likes 1150;

If predictive then provide market information to User 1170, optionally a record may be created for Alpha Source with the basis and/or analytics that resulted in the determination of predictive; and,

If not predictive then optionally create record in Alpha Source database of non-predictive information and basis and/or analytics for determination of not predictive 1175.

In other exemplars of this disclosure and within the scope of this disclosure is tracking across User accounts at various sources or targets (based on foregoing or future actions) if User has acted upon Alpha Source offer by contacting, purchasing, using or investigating an offer and the time frame and mechanism of that activity.

### EXAMPLE 8

### Marketing to User

Verified User connects with Alpha Source server 1000;

User Computing Devices interfaces with Alpha Source servers and create a Target List for User Identifying other User accounts at non Alpha Sources. Creating the list may include confirming, adding to, editing and deleting suggestions 1010 Optionally, Alpha Source may obtain permission from User, to obtain and use User credit report data to suggest Sources 1 . . . N to add to User's Target List;

User supplies or verifies account information to give Alpha Source access to User Records or to allow Alpha Source to request User Records from Sources 1 . . . N. 1020;

Obtained User records, data and meta data concerning the acquisition of the User records as well as the records are stored in a Alpha Source database 1025 which may be local to Alpha Source or remote;

Alpha Source, with express permission from User analyzes and filters obtained Records via rules and decsioning engines, software and algorithms 1030;

Records are divided into at least two groupings consisting of User activity records 1100 and Source specific records 1200;

User Activity records are parsed further 1110 into at least habit records 1120 and spending action records 1130;

Source specific records are further parsed 1210 into at least performance records 1220 and Benefit records 1230;

Alpha Source servers apply predictive models and analytics to at least one User Activity record and one Source Specific Record to identify information more likely to fit, or be predictive of, User wants, needs and likes 1140;

If predictive then provide market information to User 1160, optionally a record may be created for Alpha Source with the basis and/or analytics that resulted ire the determination of predictive; and,

If not predictive then optionally create record in Alpha Source database of non-predictive information and basis and/or analytics for determination of not predictive 1165.

In other exemplars of this disclosure and within the scope of this disclosure is tracking across User accounts at various sources or targets (based on foregoing or future actions) if User has acted upon Alpha Source offer by contacting, purchasing, using or investigating an offer and the time frame and mechanism of that activity.

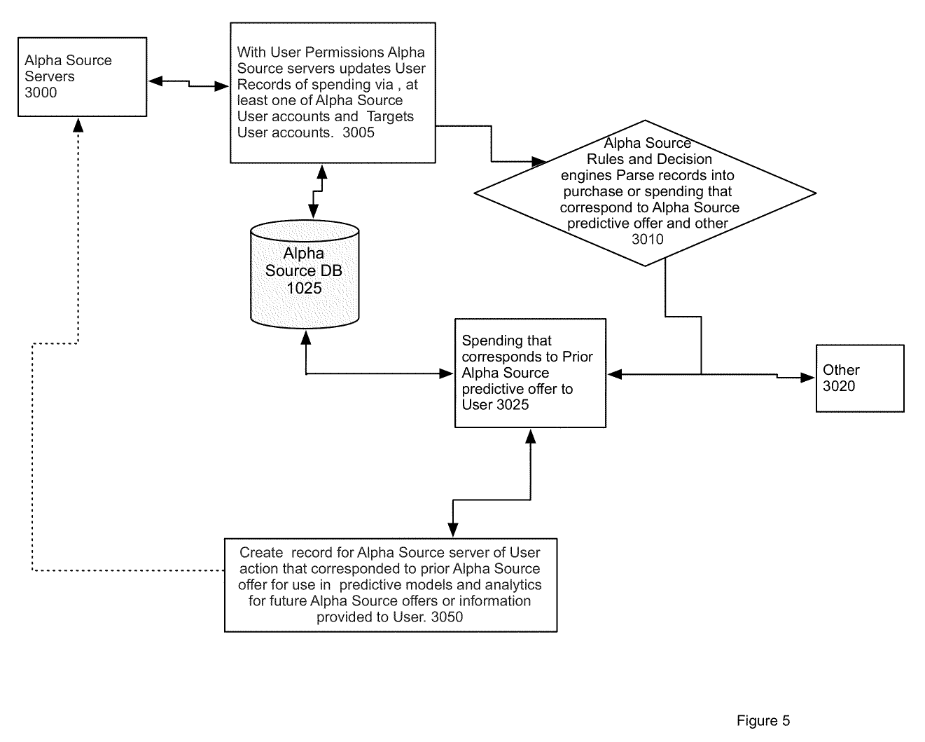

FIG. 5 illustrates aspects of exemplary implementations of a method and system utilizing acquired permissioned User records to confirm, affirm, improve, debug or otherwise check User responses to Alpha Source predictive systems and algorithms.

### EXAMPLE 9

Alpha Source Servers 3000 having User express permission update User Records of at least one of habits and spending via, at least one of Alpha Source User accounts and Targets User accounts. 3005

Obtained User records, data and meta data concerning the acquisition of the User records as well as the records are stored in a Alpha Source database 1025 which may be local to Alpha Source or remote;

Alpha Source Rules and Decision engines Parse records 3010 into purchase or spending that correspond to other 3020 and Alpha Source predictive offer 3025;

Create record in database 1025 of User action that corresponded to prior Alpha Source offer for use in predictive models and analytics for future Alpha Source offers or information provided to User 3050.

In the following description of examples of implementations, reference is made to the accompanying drawings that form a part hereof, and which show, by way of illustration, specific implementations of the present disclosure that may be utilized.

Other implementations may be utilized and structural changes may be made without departing from the scope of the present disclosure. All callouts in all figures are incorporated by this reference as if fully set forth herein. While the method and agent have been described in terms of what are presently considered to be the most practical implementations and aspects thereof, it is to be understood that the disclosure need not be limited to the disclosed implementations, aspects or order and/or sequence of combination of aspects. It is intended to cover various modifications and similar arrangements included within the spirit and scope of the claims, the scope of which should be accorded the broadest interpretation so as to encompass all such modifications and similar structures. The present disclosure includes any and all implementations of the following claims. It should also be understood that a variety of changes may be made without departing from the essence of the disclosure. Such changes are also implicitly included in the description. They still fall within the scope of this disclosure. It should be understood that this disclosure is intended to yield a patent covering numerous aspects both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the implementation, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting, such statements are expressly not to be considered as made by the applicant(s). In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such ‘alternatives.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible. All callouts associated with figures are hereby incorporated by this reference.

Since certain changes may be made in the above system, method, process and or apparatus without departing from the scope of the disclosure herein involved, it is intended that all matter contained in the above description, as shown in the accompanying drawing, shall be interpreted in an illustrative, and not a limiting sense.

While various embodiments of the disclosure have been described, it will be apparent to those of ordinary skill in the art that many more embodiments and implementations are possible within the scope of this disclosure. Moreover, it will be understood that the foregoing description of numerous implementations has been presented for purposes of illustration and description. It is not exhaustive and does not limit the claimed disclosures to the precise forms disclosed. Modifications and variations are possible in light of the above description or may be acquired from practicing the disclosure. The claims and their equivalents define the scope of the disclosure. Accordingly, the disclosure is not to be restricted except in light of the attached claims and their equivalents.

Such terms should be interpreted in their most expansive forms so as to afford the applicant the broadest coverage legally permissible.

I claim:

1. A method of predictive Alpha Source product offerings, the method comprising:
a verified User connects with Alpha Source server;
user's Computing Devices interfaces with Alpha Source servers and create a Target List identifying User accounts at non Alpha Source;
User supplies or verifies account information to give Alpha Source access to User Records or to allow Alpha Source to request User Records from Targets;
Alpha Source, with express permission from User analyzes and filters obtained Records via rules and decsioning engines, software and algorithms;
User activity records are identified;
User Activity records are parsed into at least habit records and spending action records; and,
predictive models and analytics are applied to User Activity records to identify offers likely to be predictive of User wants, needs and likes.

2. The method of claim 1 the method further comprising if predictive then provide market information to User.

3. The method of claim 2 the method further comprising creating a database entry with the analytics that resulted in the determination of predictive.

4. The method of claim 2 the method further comprising creating a database entry with the analytics that resulted in the determination of not predictive.

5. The method of claim 1 wherein creating the target list may include confirming, adding to, editing and deleting Alpha Source suggestions.

6. The method of claim 1 wherein in creating the target Alpha Source may obtain permission from User to obtain and use User credit report data to suggest Sources 1 . . . N to add to Target list.

7. The method of claim 2 the method further comprising determining if User acted on predictive information provided to User by Alpha Source on a activity or purchase.

8. A method of predictive Alpha Source product offerings, the method comprising:
a verified User connects with Alpha Source server;
user's Computing Devices interfaces with Alpha Source servers and create a Target List identifying User accounts at non Alpha Source.
User supplies or verifies account information to give Alpha Source access to User Records or to allow Alpha Source to request User Records from Targets;
Alpha Source, with express permission from User analyzes and filters obtained Records via rules and decsioning engines, software and algorithms;
User activity records are identified;
User Activity records are parsed into at least habit records and spending action records; and,
predictive models and analytics are applied to User Activity records to identify offers likely to be predictive or fit User wants, needs and likes.

9. The method of claim 8 the method further comprising if predictive then provide market information to User.

10. The method of claim 9 the method further comprising creating a database entry with the analytics that resulted in the determination of predictive.

11. The method of claim 9 the method further comprising creating a database entry with the analytics that resulted in the determination of not predictive.

12. The method of claim 8 the method further comprising identifying if User acted on offer provided to User by Alpha Source on an activity or purchase.

13. A method of predictive analytics, the method comprising:
an Alpha Source with user express permissions accesses User records from Targets;
Alpha Source analyzes and filters obtained records via rules and decsioning engines, software and algorithms;
User Activity records are parsed into at least habit records and spending action records; and,
predictive models and analytics are applied to one of User spending actions and habits to identify offers likely to be predictive or fit User wants, needs and likes.

14. The method of claim 13 the method further comprising analyzing if User acted on offer provided to User by Alpha Source on an activity or purchase.
